(19) United States
(12) Patent Application Publication
(10) Pub. No.: US 2012/0131247 A1
(43) Pub. Date: May 24, 2012

(54) APPARATUS FOR PERIPHERAL DEVICE CONNECTION USING SPI IN PORTABLE TERMINAL AND METHOD FOR DATA TRANSMISSION USING THE SAME

(75) Inventor: Jin-Young Mok, Suwon-si (KR)

(73) Assignee: SAMSUNG ELECTRONICS CO., LTD., Suwon-si (KR)

(21) Appl. No.: 13/299,329

(22) Filed: Nov. 17, 2011

(30) Foreign Application Priority Data
Nov. 22, 2010 (KR) 10-2010-0116497

(51) Int. Cl. G06F 13/40

(52) U.S. Cl. 710/110

(57) ABSTRACT

In one embodiment, an apparatus for peripheral device connection using a Serial Peripheral Interface (SPI) in a portable terminal is provided and a method for data transmission using the same. The apparatus includes an SPI controller for activating each of slaves by independently assigning at least one serial data line to each of the slaves that reads/writes data from/to each of the slaves through at least one serial control line, a slave unit including at least one slave which under the control of the SPI controller, reads out data from the buffer and then performs data transmission between the slaves, and a buffer for temporarily storing the data to be transmitted in order to transmit data between the slaves which may have different data processing speeds and different data transmission speeds.

### CROSS-REFERENCE TO RELATED APPLICATION(S) AND CLAIM OF PRIORITY

The present application is related to and claims priority under 35 U.S.C. §119(a) to a Korean Patent Application entitled “Apparatus for Peripheral Device Connection using SPI in Portable Terminal and Method for Data Transmission using the Same” filed in the Korean Intellectual Property Office on Nov. 22, 2010 and assigned Serial No. 10-2010-0116497, the contents of which are incorporated herein by reference.

### TECHNICAL FIELD OF THE INVENTION

The present invention relates to data communication, and more particularly, to an apparatus for connection using SPI in portable terminals and method for data transmission using the same.

### BACKGROUND OF THE INVENTION

Data transmission between portable terminals may be provided that uses Bluetooth communication technologies. Bluetooth provide data communication between a portable terminal and another portable terminal. Often, this may be a preferred mode of data communication in regions having a low Personal Computer (PC) penetration rate.

Using a scheme for the data transmission between portable terminals that employs Bluetooth, a new scheme for data transmission has been implemented using two Secure Digital (SD) card sockets included in a single terminal. In response to this trend, there has also been an increasing demand for supporting the functions of dual SD cards capable of performing the two schemes for data transmission.

FIG. 1 is a block diagram illustrating the configuration of a portable terminal, which includes a low-priced baseband chip, employing a Code Division Multiple Access (CDMA) protocol. Referring to FIG. 1, the portable terminal includes a baseband unit 100, a NOR flash/PSRAM (Pseudo SRAM) memory module 114, an AP (Application Processor) chip 116 which is an external multimedia processor including an MP-3 (Moving Picture Experts Group Audio Layer-3) encoder and an SD I/F (Secure Digital Interface), SD1 120 and SD2 122 supporting an SPI (Serial Peripheral Interface) slave mode, and a Bluetooth device 118.

Accordingly, the portable terminal uses the SD card I/F and various applications, such as an MP-3 playback function, by using the AP chip 116. However, when the AP chip 116 is additionally included in the portable terminal as described above, the AP chip 116 requires a relatively large region of a printed circuit board (PCB) that often increases its cost, and may also restrict data transmission as well.

### SUMMARY OF THE INVENTION

To address the above-discussed deficiencies of the prior art, it is a primary object to provide an apparatus for peripheral device connection using a Serial Peripheral Interface (SPI) in a portable terminal and a method for data transmission using the same. In one aspect, the apparatus and method may provide communication and functions between peripheral slaves that are performed by using the SPI among various serial interfaces supported for connecting external peripheral devices instead of an AP chip, to a baseband chip of the portable terminal.

In accordance with an aspect of the present invention, an apparatus for peripheral device connection using a Serial Peripheral Interface (SPI) in a portable terminal includes an SPI controller for activating each of slaves by independently assigning at least one serial data line to each of the slaves that reads/writes data from/to each of the slaves through at least one serial control line, a slave unit including at least one slave that under the control of the SPI controller, reads out data from the buffer and then performs data transmission between the slaves, and a buffer for temporarily storing the data to be transmitted in order to make a connection between the slaves which have different data processing speeds and different data transmission speeds.

In accordance with another aspect of the present invention, a method for data transmission using a Serial Peripheral Interface (SPI) in a portable terminal includes the steps of activating each of slaves by independently assigning at least one serial data line to each of the slaves, reading data from a selected slave after selecting the slave for which data transmission is intended to be performed among the activated slaves, and temporarily storing the read data, selecting a slave to which the temporarily stored data is intended to be transmitted, and writing the temporarily stored data to the selected slave.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example configuration of a portable terminal that includes a low-priced baseband chip employing a Code Division Multiple Access (CDMA) protocol;

FIG. 2 illustrates an example configuration of an apparatus for peripheral device connection using an SPI in a portable terminal according to an embodiment of the present invention;

FIG. 3 illustrates an example connection between an SPI controller and each slave connected to the SPI controller in an apparatus for peripheral device connection using an SPI in a portable terminal according to an embodiment of the present invention; and

FIG. 4 illustrates an example flowchart showing a method for data transmission using an SPI in a portable terminal according to an embodiment of the present invention.

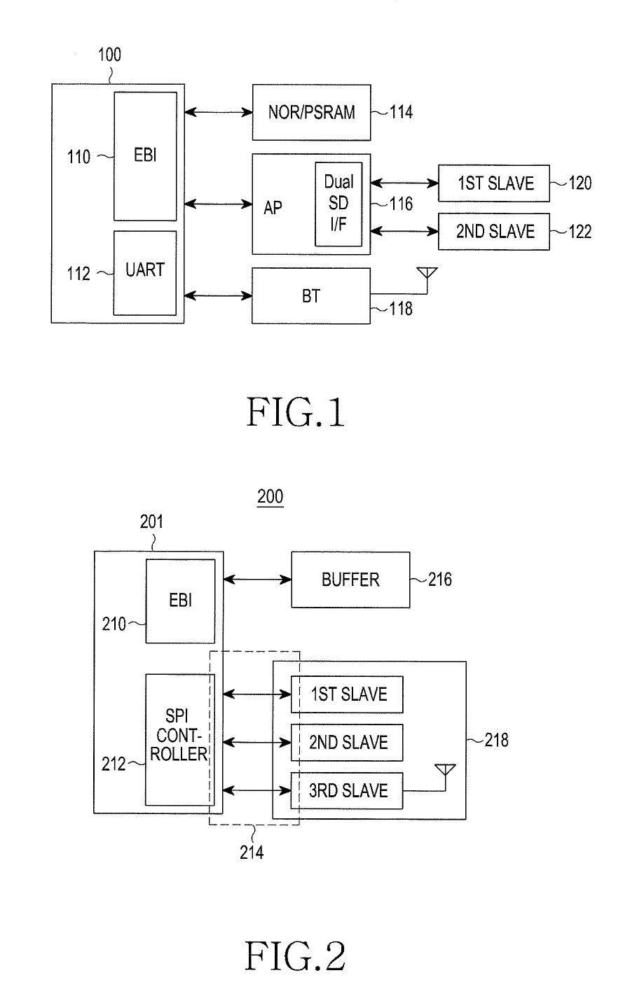

### DETAILED DESCRIPTION OF THE INVENTION

FIGS. 2 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged peripheral connecting devices. Hereinafter, exemplary embodiments of the present invention will be described in detail with reference to the accompanying drawings. The following description includes specific details, and the specific details are only provided to help more general understanding of the present invention. Therefore, it will be apparent to a person having ordinary knowledge in the technical field of the present invention that predetermined changes in form and details may be made in the specific details without departing from the scope of the present invention.

The present invention provides an apparatus for connecting multiple slave peripheral devices to a baseband chip of a portable terminal by using a Serial Peripheral Interface (SPI) among various serial interfaces supported for connecting external peripheral devices to the baseband chip of the portable terminal and a method for data transmission using the same. Particularly, the portable terminal includes both an application, such as an MP-3 player, that may be configured to have a relatively large amount of data and an SPI controller in the baseband chip, instead of an Application Processor (AP) chip which supports data exchange between the multiple slaves. Accordingly, certain embodiments of the apparatus and method may provide a portable terminal that performs communication and various functions between the peripheral slaves through the SPI controller. After transmitting an SPI clock signal and a selection signal to each slave through serial data lines and serial control lines, the SPI controller reads or writes data between the slaves so that it can process the data. Therefore, the present invention may provide a technology that improves various application functions and a data transmission speed between the SPI controller and each peripheral device without necessarily requiring a separate AP chip to the portable terminal.

Also, it will be apparent that the portable terminal according to an embodiment of the present invention can provide SPI-based communications with each peripheral device, and can be applied to many types of communication devices and many types of multimedia devices, including a digital broadcasting terminal, a PDA (Personal Digital Assistant), a smart phone, and 3G (third generation) terminals, for example, an IMT-2000 (International Mobile Telecommunication 2000) terminal, a WCDMA (Wideband Code Division Multiple Access) terminal, a GSM/GPRS (Global System for Mobile Communications/General Packet Radio Service) terminal, and a UMTS (Universal Mobile Telecommunication Service) terminal, etc. and can be applied to applications of all types of the information communication devices and all types of the multimedia devices.

Hereinafter, an apparatus for peripheral device connection using an SPI in a portable terminal according to an embodiment of the present invention will be described in detail with reference to FIG. 2.

FIG. 2 illustrates an example configuration of the portable terminal that provides a peripheral device connection using the SPI in the portable terminal according to the embodiment of the present invention.

Referring to FIG. 2, the portable terminal 200 includes a baseband unit 201, a buffer 216, a UART (Universal Asynchronous Receiver/Transmitter) 214, and one or more slave units 218.

The baseband unit 201 includes an EBI (External Bus Interface) 210 corresponding to a bus interface for enabling access to an external memory, and an SPI controller 212 for activating each slave by independently assigning at least one serial data line to each slave and controlling reading/writing of data from/to each slave through at least one serial control line. In this case, the at least one serial control line includes an SPI clock (CLK) for controlling a synchronization signal between the slaves, and a MOSI (Master Out Slave In) line and a MISO (Master In Slave Out) line for exchanging data while being synchronized with the SPI CLK.

The SPI controller 212 performs serial data transmission while being synchronized with the SPI CLK, and uses a synchronous serial full-duplex communication protocol.

The SPI controller 212 also performs the data transmission between slaves by controlling both an operation for reading the data stored in a particular slave through the MISO line of the at least one serial control line and an operation for temporarily storing the read data in the buffer 216. The SPI controller 212 may then write the data temporarily stored in the buffer 216 to a selected slave through the MOSI line of the at least one serial control line.

Further, after at least one slave is arranged, the SPI controller 212 selects a particular slave by using a Selection Signal (SS) line for enabling the selection of a node of the particular slave among the arranged slaves. Then, the SPI controller 212 communicates with the particular selected slave through the UART 214. In one embodiment, the SPI controller connects to each peripheral device through six lines in a full-duplex synchronous scheme. In this particular embodiment, the SPI controller 212 may include three serial control lines and three serial data lines.

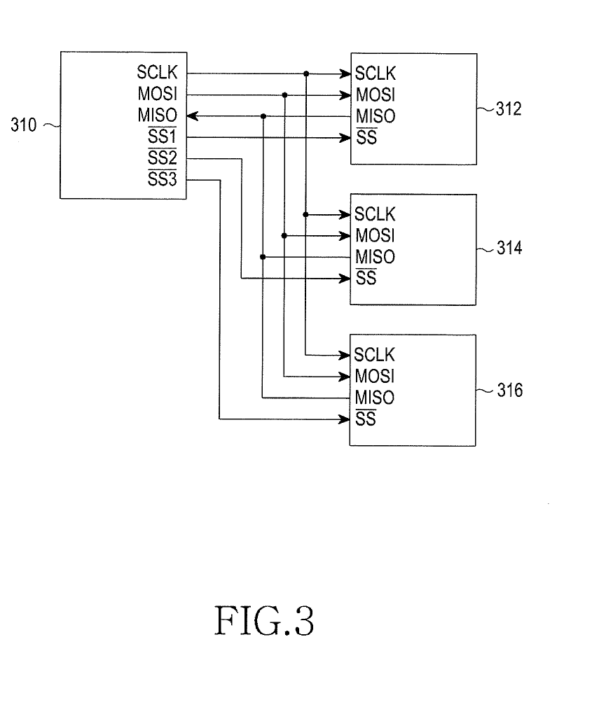

Hereinafter, the operation of the SPI controller will be described in more detail with reference to FIG. 3. FIG. 3 illustrates an example wire connection diagram providing a connection between the SPI controller and each slave in the apparatus for the peripheral device connection using the SPI in the portable terminal according to an embodiment of the present invention.

Referring to FIG. 3, when serial control lines include an SPI CLK for controlling a synchronization signal between slaves and a MOSI line and a MISO line for exchanging data while being synchronized with the SPI CLK, the SPI controller 310 may be connected to a slave 312 in such a manner that the serial control lines of the SPI controller 310 are connected to lines of the slave 312 in one-to-one manner in a serial fashion. Also, the SPI controller 310 is connected to each of slaves 314 and 316 through the same serial control lines that are connected to the slave 312 in one-to-one manner in a parallel fashion.

Further, Selection Signal (SS) lines SS1, SS2 and SS3, which are serial data lines of the SPI controller 310, are independently assigned to the slaves 312, 314 and 316, respectively, so that the SS lines SS1, SS2 and SS3 can be used to activate the slaves 312, 314 and 316, respectively.

After at least one slave is arranged, the SPI controller 310 selects a particular slave by using the Selection Signal lines SS1, SS2 and SS3 for enabling the selection of a node of the particular slave among the arranged slaves 312, 314 and 316. Then, the SPI controller 310 communicates with the particular selected slave.

The slave unit 218 includes at least one slave which, under the control of the SPI controller 212, reads data from the buffer and then performs data transmission between the slaves.

The buffer 216 temporarily stores the data to be transmitted in order to synchronize a connection between the slaves which may potentially have different data processing speeds and different data transmission speeds.

The portable terminal described above has been made of the configuration of the apparatus for the peripheral device connection using the SPI in the portable terminal according to an embodiment of the present invention.

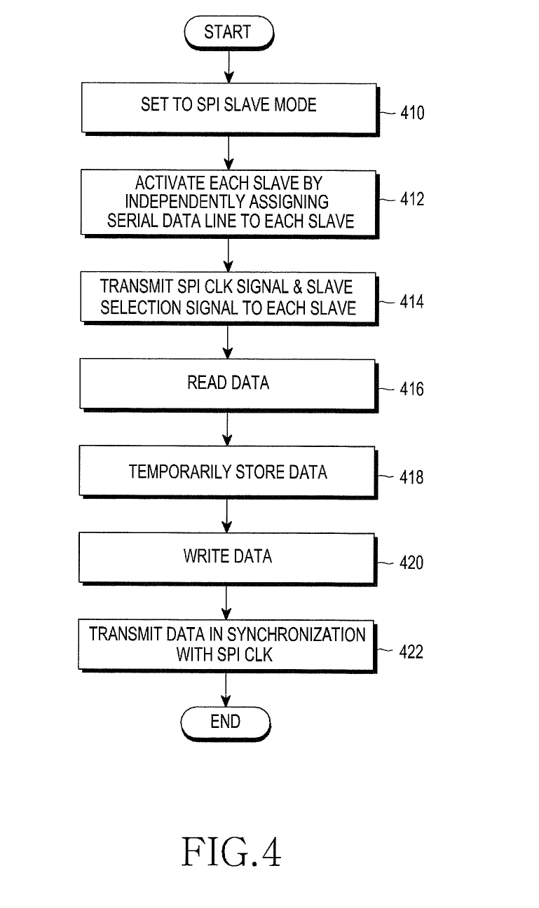

As will be described in detail below, a method for data transmission using the SPI in the portable terminal according to an embodiment of the present invention will be described in detail with reference to FIG. 4.

FIG. 4 illustrates an example flowchart showing the method for the data transmission using the SPI in the portable terminal according to one embodiment of the present invention.

First, in step 410, the portable terminal is set to an SPI slave mode.

Next, in step 412, each slave is activated by independently assigning at least one serial data line to each slave.

Next, in step 414, SPI communication is performed by transmitting an SPI CLK signal and a selection signal to each slave.

In step 416, after a slave, for which data transmission is intended to be performed among the activated slaves, is selected, data is read from the selected slave. The data may be read through a MISO line of the SPI controller, and in step 418, the read data is temporarily stored in the buffer. Storing the read data in the buffer has been performed in order to synchronize a connection between the slaves which may have different data processing speeds and/or different data transmission speeds.

In step 418, a slave, to which the data temporarily stored in the buffer is intended to be transmitted, is selected. After the data is written to the selected slave through the MOSI line of the SPI controller (step 420), data transmission, in step 422, is performed while being synchronized with the SPI CLK.

At this time, if the slave, to which the data temporarily stored in the buffer is intended to be transmitted, is a Bluetooth System On Chip (SOC), the data is transmitted to the counterpart device (i.e. the Bluetooth SOC), in synchronization with the SPI CLK, through a Bluetooth antenna.

According to the present invention as described above, an SPI controller is provided in a baseband chip of a portable terminal rather than an AP chip which supports data exchange between the peripheral slaves connected to the portable terminal. After transmitting an SPI clock signal and a selection signal to each slave through serial data lines and serial control lines of the SPI controller, the SPI controller reads or writes data between the slaves so that it may process the data. Therefore, it is possible to improve various application functions and a data transmission speed between the SPI controller and each peripheral device without using a separate AP chip to the portable terminal.

The configuration and the operation as described above may be implemented in the apparatus for the peripheral device connection using the SPI in the portable terminal and the method for the data transmission using the same according to the exemplary embodiments of the present invention. Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An apparatus for peripheral device connection using a Serial Peripheral Interface (SPI) in a portable terminal, the apparatus comprising:
an SPI controller for activating each of a plurality of slaves by independently assigning at least one serial data line to each of the slaves, and then reading/writing data from/to each of the slaves through at least one serial control line;
a slave unit comprising at least one slave which under the control of the SPI controller, reads out data from the buffer and then performs data transmission between the slaves; and
a buffer for temporarily storing the data to be transmitted in order to make a connection between the slaves which have different data processing speeds and different data transmission speeds relative to one another.

2. The apparatus as claimed in claim 1, wherein the at least one serial control line comprises an SPI Clock (CLK) for controlling a synchronization signal between the slaves, and a Master Out Slave In (MOSI) line and a Master In Slave Out (MISO) line for exchanging data while being synchronized with the SPI CLK.

3. The apparatus as claimed in claim 1, wherein the SPI controller performs serial data transmission while being synchronized with the SPI CLK.

4. The apparatus as claimed in claim 1, wherein the SPI controller operates according to a synchronous serial full-duplex communication protocol.

5. The apparatus as claimed in claim 1, wherein when at least one of the slaves have been arranged, the SPI controller selects at least one slave by using a Selection Signal (SS) line for enabling selection of a node of the at least one slave among the slaves, and then communicates with the at least one slave.

6. The apparatus as claimed in claim 1, wherein the SPI controller performs the data transmission between slaves by controlling both an operation for reading the data stored in a particular slave through a MISO line of the at least one serial control line and an operation for temporarily storing the read data in the buffer and then writing the data temporarily stored in the buffer to another slave through a MOSI line of the at least one serial control line.

7. A method for data transmission using a Serial Peripheral Interface (SPI) in a portable terminal, the method comprising:
activating a plurality of slaves by independently assigning at least one serial data line to each of the slaves;
reading data from one of the slaves after selecting the one slave for which data transmission is intended to be performed among the activated slaves; and
temporarily storing the read data, selecting a second slave to which the temporarily stored data is intended to be transmitted, and writing the temporarily stored data to the second slave.

8. The method as claimed in claim 7, wherein reading the data is performed using a Master In Slave Out (MISO) line of a serial control line.

9. The method as claimed in claim 7, wherein the data transmission is performed such that the data is transmitted in synchronization with an SPI clock (CLK).

10. The method as claimed in claim 7, wherein the data transmission is performed by selecting one slave for data transmission, reading data from the one slave, temporarily storing the read data, and transmitting the temporarily stored data to a counterpart device through an antenna of another slave comprising a Bluetooth slave.

11. The method as claimed in claim 7, wherein activating the slaves comprises transmitting an SPI CLK signal and a slave selection signal to each of the slaves.
